(19) United States
(12) Patent Application Publication
(10) Pub. No.: US 2023/0213064 A1
(43) Pub. Date: Jul. 6, 2023

(54) ANTI-ROTATION BUSHING FOR STEERING ASSEMBLY RACK EPS SYSTEM

(71) Applicant: Steering Solutions IP Holding Corporation, Saginaw, MI (US)

(72) Inventors: Sainan Feng, Saginaw, MI (US); Brian Magnus, Frankenmuth, MI (US); Josh Mullins, Bay City, MI (US)

(21) Appl. No.: 17/568,126

(22) Filed: Jan. 4, 2022

(51) Int. Cl. F16C 33/06; B62D 5/00

(52) U.S. Cl. CPC F16C 33/06; B62D 5/001; F16C 2326/24

(57) ABSTRACT

A steer-by-wire steering system for a vehicle includes a rack moveable in an axial direction, the rack having a bushing engagement portion comprising an outer surface including a plurality of rack flat surfaces. The steering system also includes an anti-rotation bushing disposed proximate an outer surface of the rack at the bushing engagement portion of the rack, the anti-rotation bushing having a plurality of bushing flat surfaces, wherein the number of the plurality of rack flat surfaces and the number of the plurality of bushing flat surfaces is identical.

### BACKGROUND

Various electric power steering (EPS) systems have been developed for assisting an operator with vehicle steering. One type of EPS system is referred to as a rack electric power steering (REPS) system. A REPS system utilizes an electric motor that drives a ball nut and rack. The rack teeth are engaged with a pinion. The pinion complements a driving feature that is rotated in response to rotation of a portion of the steering column by an operator, with the driving feature providing a steering input to the rack. The driving feature may be integrated with the steering column (i.e., single pinion electric power steering system) or may be a driving pinion (i.e., dual pinion electric power steering system), for example.

OEMs may be interested in removing the pinion for better packaging and cost during development of steer-by-wire gear systems.

### SUMMARY

According to one aspect of the disclosure, a steer-by-wire steering system for a vehicle includes a rack moveable in an axial direction, the rack having a bushing engagement portion comprising an outer surface including a plurality of rack flat surfaces. The steering system also includes an anti-rotation bushing disposed proximate an outer surface of the rack at the bushing engagement portion of the rack, the anti-rotation bushing having a plurality of bushing flat surfaces, wherein the number of the plurality of rack flat surfaces and the number of the plurality of bushing flat surfaces is identical.

According to another aspect of the disclosure, an anti-rotation bushing for a steer-by-wire vehicle steering system includes a first axial end. The anti-rotation bushing also includes a second axial end. The anti-rotation bushing further includes a radially outer surface. The anti-rotation bushing yet further includes a radially inner surface including a first bushing flat surface, a second bushing flat surface, a third bushing flat surface and a fourth bushing flat surface, wherein the first and second bushing flat surfaces are angled relative to each other to define a Y-shaped first pair of flat surfaces, wherein the third and fourth bushing flat surfaces are angled relative to each other to define a Y-shaped second pair of flat surfaces.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 illustrates a steering assembly with an electric power steering assist system;

FIG. 2 is a perspective view of an anti-rotation bushing for the rack electric power steering assist system;

FIG. 3 is a schematic, cross-sectional view of the anti-rotation bushing; and

FIG. 4 is a schematic, cross-sectional view of the rack.

### DETAILED DESCRIPTION

Referring now to the Figures, the embodiments described herein are used in conjunction with a steering assembly of a vehicle, such as a car, truck, sport utility vehicle, crossover, mini-van, marine craft, aircraft, all-terrain vehicle, recreational vehicle, or other suitable vehicles, including various steering system schemes.

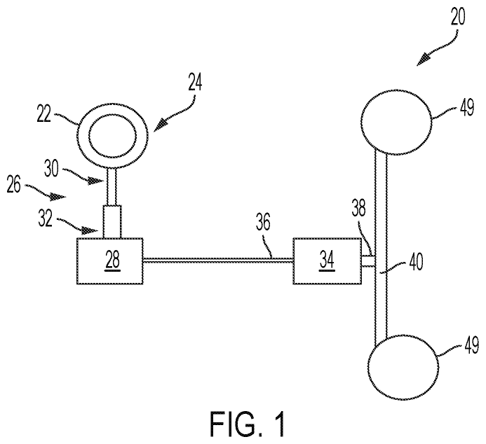

Referring initially to FIG. 1, the power steering system 20 is generally illustrated. The power steering system 20 may be configured as a driver interface steering system, an autonomous driving system, or a system that allows for both driver interface and autonomous steering. The steering system may include an input device 22, such as a steering wheel, wherein a driver may mechanically provide a steering input by turning the steering wheel. An airbag device 24 may be located on or near the input device 22. A steering column 26 extends along an axis from the input device 22 to an output assembly 28. The steering column 26 may include at least two axially adjustable parts, for example, a first portion 30 and a second portion 32 that are axially adjustable with respect to one another. The embodiments disclosed herein are utilized in steering systems where the output assembly 28 is in operative communication with an actuator 34 that is coupled to a rack 40, i.e. steer-by-wire configuration. The output assembly 28 has wired communication with the actuator 34. Actuator 34 drives either the pinion 38 which in turn drives the rack 40 or, alternatively, the actuator 34 drives the rack 40 directly. The rack 40 is surrounded radially by a rack housing.

In prior steer-by-wire steering systems, a pinion 38 is utilized on an outer surface of the rack 40 to provide steering input control of the rack 40 and anti-rotation reaction forces on the rack 40. However, the pinion and associated required components (e.g., pinion upper and lower bearing, rack bearing, adjuster plug, lower rotor, and rack teeth, etc.) are undesirable based on packaging requirements, cost, and manufacturing complexity, for example. The embodiments of an anti-rotation bushing 50 disclosed herein provide the anti-rotation benefits of the previously required pinion, while eliminating the numerous components noted above. The above-referenced steering input control of the rack 40 with a pinion is unnecessary in a steer-by-wire steering system.

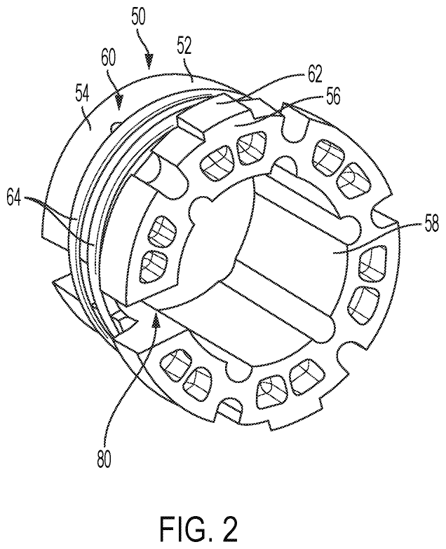

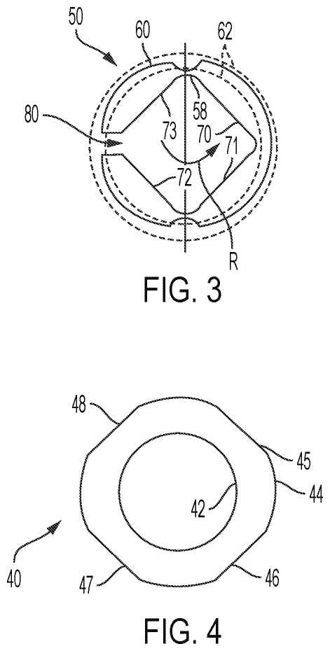

Referring now to FIGS. 2 and 3, an anti-rotation bushing 50 is shown. In some embodiments, the anti-rotation bushing is formed of plastic. The anti-rotation bushing 50 is positioned within the rack housing and on an outer surface of the rack 40. The anti-rotation bushing 50 guides translational movement of the rack 40 during axial movement of the rack 40 along a rack longitudinal axis, while preventing rolling or rotating of the rack 40.

The anti-rotation bushing 50 has a main body portion 52 extending from a first axial end 54 to a second axial end 56. The anti-rotation bushing 50 also includes a radially inner surface 58 and a radially outer surface 60. The radially outer surface 60 has a substantially circular profile along a majority of the axial length and has a plurality of retention features 62, such as the illustrated tabs or the like. The retention features 62 engage the rack housing to prevent rotation and translation of the anti-rotation bushing 50, thereby maintaining a constant circumferential and axial position of the anti-rotation bushing 50, relative to the rack housing.

At least one O-ring 64 is provided on the radially outer surface 60. As shown, two or more O-rings 64 may be provided in some embodiments. Regardless of the precise number of O-rings 64, the O-rings 64 provide a delashing effect on the anti-rotation bushing 50.

The radially inner surface 58 of the anti-rotation bushing 50 includes what may be referred to as a “double Y” reaction surface structure. The double Y structure is shown best in the cross-sectional view of the anti-rotation bushing 50 in FIG. 3. In particular, the radially inner surface 58 is defined by two pairs of substantially flat surfaces, i.e. four flat surfaces 70, 71, 72, 73.

Referring now to FIG. 4, a cross-section of a portion of the rack 40 that is located within the anti-rotation bushing 50 is illustrated. The rack 40 also includes a radially inner surface 42 and a radially outer surface 44. The illustrated portion of the rack 40 does not require teeth to be formed on the radially outer surface 44 since axial movement of the rack 40 is not driven by a pinion in the steer-by-wire embodiments disclosed herein. Rather, the radially outer surface 44 of the rack 40 at the location positioned within the anti-rotation bushing 50 includes a number (i.e., four) of flat surfaces 45, 46, 47, 48 thereon which corresponds to the number of flat surfaces 70-73 of the anti-rotation bushing 50.

The flat surfaces 70-73 are in contact with or in close proximity to the flat surfaces 45-48 of the rack 40. Additionally, the angle of the flat surfaces 70-73 of the anti-rotation bushing 50 and the flat surfaces 45-48 of the rack 40 substantially align with each other. The corresponding geometry allows axial movement of the rack 40 during operation, while also preventing significant rolling or rotation of the rack 40. For example, as shown in FIG. 3, attempted rotation of the rack 40 that is represented with rotational arrow R is countered by the reaction forces imparted on the rack 40 by flat surfaces 70, 72 of the anti-rotation bushing 50. As one can appreciate, rotation in the opposite direction would be countered by reaction forces imparted on the rack 40 by flat surfaces 71, 73.

The angle and length of the flat surfaces (45-48 and 70-73) of both the anti-rotation bushing 50 and the rack 40 may be customized to a particular application of use. In some applications, it will be beneficial to have longer lengths of the flat surfaces and/or steeper angles.

Referring again to FIG. 2, the anti-rotation bushing 50 also defines a gap 80 in some embodiments. The gap 80 extends along the entire axial length (i.e., first axial end 54 to second axial end 56) in the illustrated embodiment, but it is contemplated that only a portion of the axial length defines the gap in other embodiments. The gap 80 allows expansion of the anti-rotation bushing 50 within the rack housing.

The embodiments disclosed herein allow for a reduction in packaging space required based on the removal of several components, including a pinion, a pinion upper and lower bearing, a rack bearing, an adjuster plug, a lower rotor, and rack teeth. Additionally, cost and complexity associated with manufacturing and assembly of the overall system is reduced with the anti-rotation bushing 50 disclosed herein.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

What is claimed is:

1. A steer-by-wire steering system for a vehicle comprising:
a rack moveable in an axial direction, the rack having a bushing engagement portion comprising an outer surface including a plurality of rack flat surfaces; and
an anti-rotation bushing disposed proximate an outer surface of the rack at the bushing engagement portion of the rack, the anti-rotation bushing having a plurality of bushing flat surfaces, wherein the number of the plurality of rack flat surfaces and the number of the plurality of bushing flat surfaces is identical.

2. The steer-by-wire steering system of claim 1, wherein the number of the plurality of rack flat surfaces is four and the number of the plurality of bushing flat surfaces is four.

3. The steer-by-wire steering system of claim 1, wherein the number of the plurality of rack flat surfaces ranges from two to six.

4. The steer-by-wire steering system of claim 2, wherein the plurality of bushing flat surfaces is grouped into a first pair of bushing flat surfaces and a second pair of bushing flat surfaces, wherein each of the first pair of bushing flat surfaces and the second pair of bushing flat surfaces are angled relative to each other to define a Y-shape.

5. The steer-by-wire steering system of claim 1, wherein the rack does not include teeth formed on the bushing engagement portion.

6. The steer-by-wire steering system of claim 1, wherein the anti-rotation bushing defines a circumferential gap to facilitate expansion of the anti-rotation bushing.

7. The steer-by-wire steering system of claim 1, wherein the anti-rotation bushing includes an O-ring disposed on a radially outer surface of the anti-rotation bushing.

8. The steer-by-wire steering system of claim 7, wherein the anti-rotation bushing includes a plurality of O-rings disposed on the radially outer surface of the anti-rotation bushing.

9. The steer-by-wire steering system of claim 1, wherein the steer-by-wire system does not have a pinion at the bushing engagement portion of the rack.

10. The steer-by-wire steering system of claim 1, wherein the anti-rotation bushing includes a plurality of radially outwardly extending tabs in contact with a rack housing to prevent rotation and translation of the anti-rotation bushing.

11. The steer-by-wire steering system of claim 1, wherein the anti-rotation bushing is formed of plastic.

12. An anti-rotation bushing for a steer-by-wire vehicle steering system comprising:
a first axial end;
a second axial end;
a radially outer surface; and
a radially inner surface including a first bushing flat surface, a second bushing flat surface, a third bushing flat surface and a fourth bushing flat surface, wherein the first and second bushing flat surfaces are angled relative to each other to define a Y-shaped first pair of flat surfaces, wherein the third and fourth bushing flat surfaces are angled relative to each other to define a Y-shaped second pair of flat surfaces.

13. The anti-rotation bushing of claim 12, wherein the anti-rotation bushing defines a circumferential gap to facilitate expansion of the anti-rotation bushing.

14. The anti-rotation bushing of claim 12, wherein the anti-rotation bushing includes an O-ring disposed on a radially outer surface of the anti-rotation bushing.

15. The anti-rotation bushing of claim 14, wherein the anti-rotation bushing includes a plurality of O-rings disposed on the radially outer surface of the anti-rotation bushing.

16. The anti-rotation bushing of claim 12, wherein the anti-rotation bushing includes a plurality of radially outwardly extending tabs positioned for contact with a rack housing to prevent rotation and translation of the anti-rotation bushing.

17. The anti-rotation bushing of claim 12, wherein the anti-rotation bushing is formed of plastic.
